(19) United States
(12) Patent Application Publication
(10) Pub. No.: US 2026/0142939 A1
(43) Pub. Date: May 21, 2026

(54) REDUCING CONVERSATION LATENCY WITH RESPONSE PRE-GENERATION

(71) Applicant: Sierra Technologies, Inc., San Francisco, CA (US)

(72) Inventors: Clayton Woodward Bavor, JR., Atherton, CA (US); Arya Asemanfar, San Francisco, CA (US)

(21) Appl. No.: 19/391,779

(22) Filed: Nov. 17, 2025

Related U.S. Application Data
(60) Provisional application No. 63/723,415, filed on Nov. 21, 2024.

(51) Int. Cl. H04L 51/02; H04L 51/04

(52) U.S. Cl. CPC H04L 51/02; H04L 51/04

(57) ABSTRACT

A system receives a portion of a user input from a real-time conversation between an agent and a user. After receiving the portion but before receiving a remainder of the user input, the system dynamically identifies indicators corresponding to an intent of the user based on the portion. The system provides the indicators to a machine learning model to predict user intents. Each predicted user intent is associated with a confidence score indicating a likelihood that the predicted user intent is an actual user intent. The system selects a set of predicted user intents based on the confidence scores and pre-generates a response to the user input for each of the set. The system detects an end of the user input responsive to receiving the remainder and selects a predicted user intent. The system presents the pre-generated response corresponding to the selected predicted user intent.

### CROSS REFERENCE TO RELATED APPLICATION

This application claims the benefit of U.S. Provisional Application No. 63/723,415, filed November 21, 2024, which is incorporated by reference.

### TECHNICAL FIELD

The disclosure generally relates to the field of artificial intelligence, and more specifically relates to a declarative agent using machine learning models.

### BACKGROUND

Agents are software that coordinate sequences of interactions with AI (artificial intelligence), such as LLMs (large language models) and external software systems. Latency refers to the time it takes for an agent to receive an input, process it, and deliver an appropriate response. During a conversation in which an AI agent is involved, the time taken to process an input, understand context, and generate an appropriate reply may introduce delays to the conversation. These delays may disrupt the natural rhythm of the conversation, making the interaction feel awkward or unnatural. Additionally, real-time voice interaction requires the AI agent to perform several complex tasks in quick succession: processing spoken language, understanding context, generating a relevant and coherent response, and delivering that response within a fraction of a second. This cannot be done in real-time in the conversation if latency from delays is introduced. The complexity of natural language processing (NLP) and the computational resources required for real-time speech synthesis make achieving low latency a difficult task.

### SUMMARY

Systems and methods are disclosed herein that mitigates latency in responses during conversations between a user and an agent, which is crucial for maintaining a smooth and natural interaction. As described herein, latency is minimized by pre-generating predicted responses to a user’s request while receiving the user’s input. The agent predicts the possible user intents/queries based on the received partial input and generates potential responses in advance of the user completing the input. When the user input has been fully received from a user, the agent may quickly determine if the input sufficiently corresponds to one of the predicted user queries, and if so, the corresponding predicted response is provided to the user, reducing latency. In some embodiments, the predicted responses may be generated while receiving the user input. Alternatively, the predicted responses may be previously generated and stored in a response repository.

In some embodiments, a system receives, via an agent, a first portion of a user input from a user during a real-time conversation between the agent and the user. After receiving the first portion of the user input but before receiving a remainder of the user input during the real-time conversation, the agent dynamically identifies one or more indicators corresponding to an intent of the user based on the first portion of the user input during the real-time conversation. The system provides the one or more indicators to a machine learning model to predict one or more user intents associated with the user input. Each predicted user intent is associated with a confidence score indicating a likelihood that the predicted user intent is an actual user intent. The system selects a set of predicted user intents based on the respective confidence scores and pre-generates at least one response to the user input for each of the set of predicted user intents. The system detects an end of the user input in response to receiving the remainder of the user input and selects one of the set of predicted user intents as the actual user intent associated with the user input based on the received remainder of the user input. The system presents the pre-generated response corresponding to the selected predicted user intent to the user as a response to the user input.

### BRIEF DESCRIPTION OF DRAWINGS

The disclosed embodiments have other advantages and features which will be more readily apparent from the detailed description, the appended claims, and the accompanying figures(or drawings). A brief introduction of the figures is below.

FIG. 1 illustrates one embodiment of a system environment for implementing a declarative agent service, in accordance with one or more embodiments.

FIG. 2 illustrates one embodiment of modules of the declarative agent service, in accordance with one or more embodiments.

FIG. 3 is a block diagram illustrating components of an example machine able to read instructions from a machine-readable medium and execute them in a processor (or controller) , in accordance with one or more embodiments.

FIG. 4 is a flowchart of a method for presenting a pre-generated response, in accordance with one or more embodiments.

### DETAILED DESCRIPTION

The Figures(FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

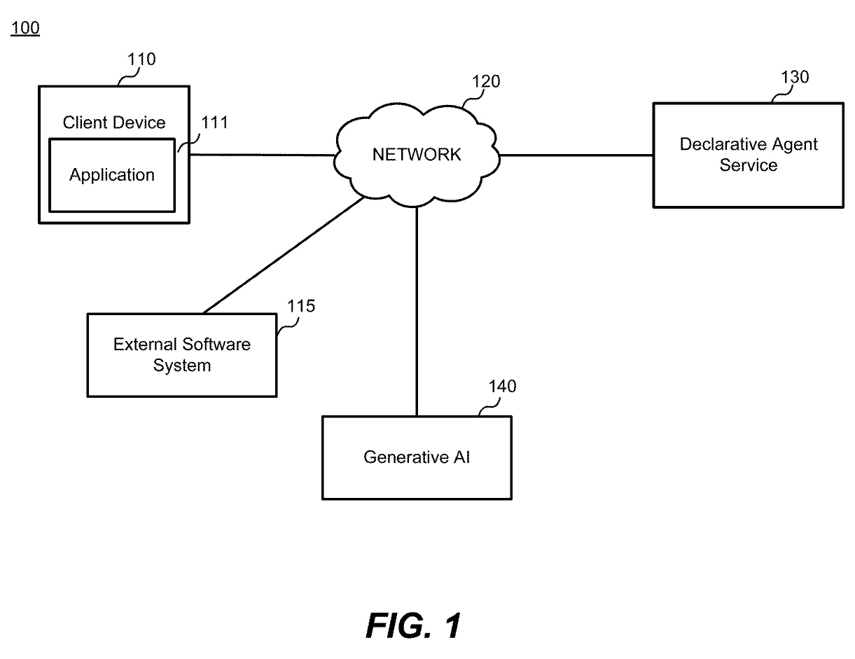

FIG. 1 illustrates one embodiment of a system environment for implementing a declarative agent service. As depicted in FIG. 1, declarative agent service environment 100 includes client device 110. While policy enforcement application 111 is only depicted with respect to one client device 110, this is for convenience only, and many number of client devices may be interacting with declarative agent service 130. Client device 110 may be any device operated by an end-user having a user interface, such as a smartphone, a laptop, a personal computer, a wearable (e.g., smart watch), a kiosk, or any other electronic device capable of interfacing between a user and declarative agent service 130.

Declarative agent service 130 may be accessed by client device 110 using application 111. Application 111 may be an application dedicated to activities of declarative agent service 130 (e.g., an installed software package downloaded from declarative agent service 130 or an external repository such as an app store, or installed using other means such as a hard disk). Alternatively or additionally, application 111 may be a browser through which declarative agent service 130’s functionality may be accessed (e.g., directly, or indirectly through an embedded portal in a website of third party company).

External software system 115 may be a software system of, e.g., a platform that utilizes declarative agent service 130. External software system 115 may require human intervention or may be utilized without a human in the loop, and may be configured to provide functionality, such as chatbot (interchangeably used with “chat automation system”) functionality to users of the platform. Client device 110 may be used by an entity controlling external software system 115 to communicate to declarative agent service 130 information sufficient to deploy guardrails on LLM outputs and/or may be used by end-users interacting with external software system 115 to resolve and otherwise chat through an issue.

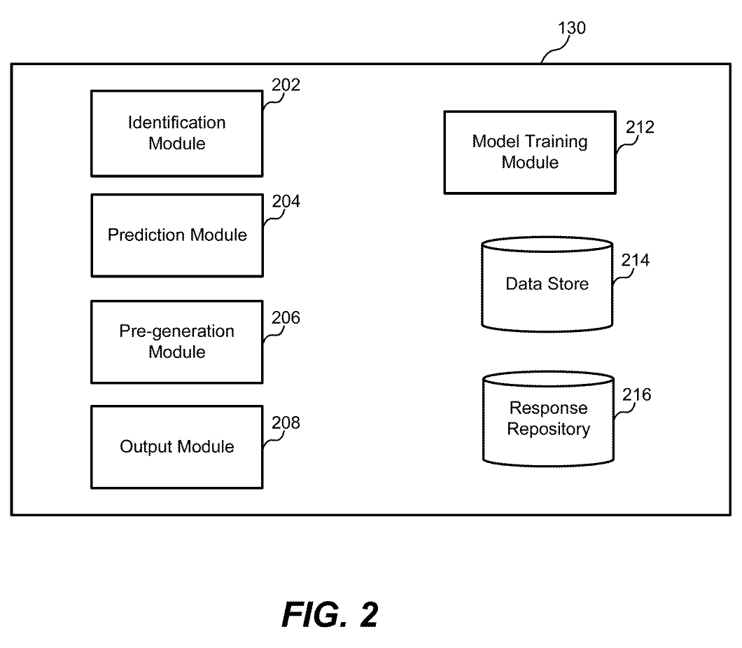

Declarative agent service 130 is used by client devices 110 and/or external software system 115 to provide a chat interface that addresses inquiries by users or by the platform of an external software system. Declarative agent service 130 is instantiated on one or more servers, accessible by way of network 120. Some or all functionality of declarative agent service 130 described herein may be distributed or fully performed by application 111 on a client device, or vice versa. Where reference is made herein to activity performed by application 111, it equally applies that declarative agent service 130 may perform that activity off of the client device, and vice versa. Declarative agent service 130 may be provided as a software development kit (SDK) to a client device or external software service to enable these entities to build the functionality of declarative agent service 130 on-premises. The SDK may export an API such that 3rd parties (e.g., client devices or external software services) can specify their agents. Agent code using the SDK API is then uploaded to declarative agent service 130, on which it can execute (and run as an agent). Further details about the operation of declarative agent service 130 are described below with reference to FIG. 2.

Generative AI 140 may be part of declarative agent service 130 or may be a third-party provider (e.g., OpenAI) that provides generative AI for processing natural language queries. Generative AI 140 may include one or many LLMs, the LLMs provided by any number of providers.

FIG. 2 illustrates one embodiment of modules of the policy enforcement service. As depicted in FIG. 2, the declarative agent service 130 includes an identification module 202, a prediction module 204, a pre-generation module 206, an output module 208, a model training module 212, a data store 214, and a response repository 216. These modules and databases are merely illustrative; fewer or more modules and/or databases may be used to achieve the functionality disclosed herein.

The identification module 202 receives an input from a user in a conversation between the user and an agent of the declarative agent service 130. In some embodiments, the user input may be a voice input. In some embodiments, as the user begins speaking, the identification module 202 captures the real-time voice input and converts it to text using speech-to-text technology. The identification module 202 may receive an input in one or more portions or divide an input into one or more portions, such that the identification module 202 may analyze the input by portion or combinations of portions as the portions are received.

The identification module 202 analyzes the input in real-time to identify indicators in the input. The indicators are used to predict the user’s intent, query, request that is associated with the user input. The indicators may include keywords, common phrases, sentence starters, input patterns, pauses in speech, etc. For example, a user’s partial input may be “Good morning. I need help with….” The identification module 202 may determine “Good morning” is not an identifier because it is generally not related to a user’s intent/request, but identify “I need help with…” as an indicator because this phrase is a common sentence starter. The identification module 202 may use it for predicting the user’s intent/query. In some examples, if the user pauses during their input or pauses after a keyword, the identification module 202 may identify the pause as an indicator to predict the user’s intent because it is likely the subsequent user input is the user’s request. For instance, a user’s request may be “I need to know the status of my order.” The user may have paused after “I need to know...,” and the pause may be identified as an indicator to predict the user’s intent. In some embodiments, one or more indicators are used to indicate an end of the input, e.g., sentence pattern, long pause, etc. When these indicators are identified and provided to the other components of the declarative agent service 130, they may trigger an overall/comprehensive analysis of user intent/request and evaluation the pre-generated responses.

In some embodiments, the identification module 202 assesses the ongoing conversation and previous interactions with the user, such as the user’s past queries, preferences, behavior, or personalized data. If the user has a history of asking similar questions or following certain patterns, the identification module 202 may use this information to identify indicators related to these questions or patterns and use those indicators to predict the user’s intent. For example, if the user frequently asks about account details after mentioning their account, the identification module 202 may identify mentioning their account as an indicator for predicting the user’s intent, e.g., “Request Account Information,” and begin a pre-generation of responses related to account issues.

In some implementations, the identification module 202 may use pre-defined rules to identify the indicators. The identification module 202 may store a list of the pre-defined indicators. While receiving the user input, the identification module 202 may dynamically generate a list of tokens/strings and compare the list of tokens/strings with the list of the pre-defined indicators to identify the indicators in the user input. In some implementations, the identification module 202 may use a machine learning model (e.g., Generative AI 140) to identify the indicators in the user input. In some embodiments, the machine learning model may be a supervised machine learning model.

The prediction module 204 receives the identified indicators and predicts the user’s intent/request based on the identified indicators. Alternatively, the prediction module 204 may directly receive the user’s input and predict the user’s intent. For example, the prediction module 204 may use a machine learning model that configured to receive the user’s input to identify indicators and predict user intent. In some implementations, as the indicators are dynamically identified during the real-time user input, the prediction module 204 may continuously predict and/or update the user’s intent/request based on the identified indicators received from the identification module 202. In some embodiments, when the prediction module 204 receives indicators that indicate an end of a user input, the prediction module 204 may perform an overall analysis on all previously received indicators and/or the user input to output a final user’s intent. If the final user’s intent is the same as one of the previously predicted user intents, the prediction module 204 may inform the other components of the declarative agent service 130 to output a corresponding pre-generated response. If the final user input is not included in the previously predicted user inputs, the prediction module 204 may inform the other components of the declarative agent service 130 to generate a response based on the final user input. The prediction module 204 may use the differences and errors in the predictions as feedback to improve the machine learning model used by the prediction module 204.

The prediction module 204 may use a machine learning model (e.g., Generative AI 140) to predict the user’s intent. In some implementations, the machine learning model may be a large language model (LLM). The predication module 204 may prepare the identified indicators as tokens/strings and input the tokens/strings to the LLM to predict the user’s intent. For example, the LLM may use next-token prediction to predict next part of the sentence, which provides clues about the user’s intent, e.g., auto-completion of the user input. The prediction module 204 may use the LLM to auto-complete a partial input in a few directions and determine the user’s intent in the different directions while user is finishing sentences. For instance, if the input is “where is ….,” the LLM may predict the next token(s) are “my order;” alternatively, the LLM may predict the next token(s) are “store location.” In some implementations, the LLM predicts the user’s intent by predicting a classification of the user’s intent. The LLM may categorize the user’s likely intent, such as “Track Order,” “Request Information,” etc.

In some embodiments, the LLM may output one or more predictions, and each predication is associated with a confidence score. A higher confidence score may indicate a high likelihood of the user’s intent being the predicted intent. For example, upon receiving a user’s input “where is…,” the prediction module 204 may auto complete the sentence, such as “where is my order?”, “where is your local store?” and the like. For the auto-completed sentence “where is my order?”, the prediction module 204 may predict the user intent has an associated confidence score, 0.57; and for the auto-completed sentence “where is your local store?” the prediction module 204 may determine the associated confidence score 0.43. In some implementations, the prediction module 204 may rank the predicted intents based on the confidence score, and select one or more predicted intents for generating responses based on the ranking (e.g., select the highest ranked as the mostly likely intent). In another example, the prediction module 204 may generate response for a predicted intent if the corresponding confidence score exceeds a predetermined threshold.

In some other embodiments, criteria for generating responses may be customized (e.g., set) by a user. For example, a user may determine certain words or combination of words as high priority indicators, and/or define certain predicted user intents as high priority intent. When the declarative agent service 130 identifies the high priority indicators and/or receives high priority intents, the declarative agent service 130 may automatically start to pre-generate responses corresponding to the high priority intents and/or intents based on the high priority indicators.

In some implementations, the machine learning model used to predict user’s intent may be a supervised machine learning model that is trained on a training dataset. The training dataset may include a plurality of training examples, and each training example may include an indicator that is labeled with a specific user intent. The machine learning model may learn from these training examples to generalize and make predictions on new, unseen data. In some implementations, the prediction module 204 may generate a training dataset by gathering user queries, historical conversations, user feedback, etc. For example, the prediction module 204 may extract queries from historical chat logs where users have previously interacted with either an agent of the declarative agent service 130 or human agents. In some examples, simulated/generated data may be created and used as training examples. The training dataset may include a wide range of query types, including different user intents. The machine learning model may be updated based on subsequent user input. For example, if the subsequent user input is different from the predicted intent, prediction module 204 may update the training dataset to include new examples, corrections, or variations that reflect the difference.

The pre-generation module 206 receives one or more predicted user intents from the prediction module 204 and generate responses based on the predicted user intents. In one example, the pre-generation module 206 may use an LLM to generate a response template corresponding to each predicted user intent. A response template may include response structures/formats that the pre-generation module 206 may quickly populate with relevant information to form a response. In some embodiments, the pre-generation module 206 may pre-store the response templates in a response repository 216. When encountering similar user intents/requests, the pre-generation module 206 may access the response repository 216, identify and reuse the stored response templates rather than generating the response templates in real-time.

In some embodiments, the pre-generation module 206 may customize the selected response templates using contextual data, such as the user’s history, preferences, or specific details mentioned earlier in the conversation. For instance, if the user frequently asks about account security, the pre-generation module 206 may customize the template to include additional security tips or links to resources.

The pre-generation module 206 populates the response template with content to generate responses based on the predicted user intents. In some embodiments, the pre-generation module 206 may include a skills module that deploys a respond skill, which re-formulates some deterministically computed information to the context of the conversation. A respond skill takes as input either a message to paraphrase or an instruction to the LLM on how to respond. The skills module combines this with the history of the conversation and context to make an LLM call to generate an agent message. The respond skill may be both a top-level skill used to provide information to a user, as well as used within other functions to aide in generation of agent messages.

The pre-generation module 206 uses the LLM to dynamically generate responses based on the user’s real-time user input, contextual information, predicted user intent, and the like. In some implementations, the LLM may access a data store, knowledge database, external data sources, external functions, etc., for preparing the response to the predicted user intent/query. For example, if the predicted user intent/query is “I need help with my account,” the LLM may output a response with account-specific details in a selected response template, such as, “Sure, I can help you with your account. I see that your last login attempt was unsuccessful—would you like to reset your password?” In some embodiments, the LLM may receive the user input as input to generate responses. For example, if a user inputs “My tracking number is 123456789, but I still have not received it, can you….,” the tracking number may be input to the LLM for retrieving relevant information for generating the response.

The output module 208 determines the generated response as the response to the user input and outputs the determined response to the user. During a voice conversation, the output module 208 may perform a text-to-voice conversion to generate an audio signal as a response to the user in a real-time conversation. The output module 208 may pre-load the pre-generated responses so that they are ready to be delivered the moment the user finishes speaking. For example, the output module 208 may put these responses in a buffer, waiting for the user’s full input to determine which response to deliver. In one implementation, the prediction module 204 may receive an indicator indicating an end of the user input and determine a final user intent/request based on the overall indicators. If the final user intent matches one of the previously predicted user intents, the prediction module 204 may notify the output module 208 to output the pre-generated response corresponding to the matched user intent. In some cases, if the final user intent does not match any of the previously predicted user intent (e.g., because the user finishes their sentence in a way that does not match any of the predicted endings), the output module 208 recognizes that none of its pre-generated responses are appropriate. In these embodiments, the output module 208 may call the skills module to generate a new response from scratch based on the full input. In some implementations, when the output module 208 determines that the pre-generated responses may lead to an incorrect interpretation (for example, when the user asks to repeat the response), the output module 208 may rephrase the response or ask for clarification without significantly disrupting the conversation flow.

The model training module 212 may apply an iterative process to train a machine-learning model whereby the model training module 212 updates parameter values of machine-learning models based on each of the set of training examples. The training examples may be processed together, individually, or in batches. To train a machine-learning model based on a training example, the model training module 212 applies the machine-learning model to the input data in the training example to generate an output based on a current set of parameter values. The model training module 212 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross-entropy loss function. The model training module 212 updates the set of parameters for the machine-learning model based on the score generated by the loss function. For example, the model training module 212 may apply gradient descent to update the set of parameters.

The model training module 212 may train various machine learning models in identifying indicators, predicting user intents, and/or generating responses. In one implementation, the machine learning models may be trained on natural language processing tasks. The trained machine learning model may analyze vast amounts of historical data to identify patterns and correlations between specific phrases, contexts, user intents and the responses. By learning from labeled datasets that include diverse user interactions and corresponding indicators, the trained machine learning models may automatically recognize when a new input matches a known indicator and/or user intent. To train the machine learning model with the training dataset, the model training module 212 may define an objective function, which guides the model in learning to predict the correct indicators and/or user intents. In some implementations, the model is trained to classify the user input into different categories of user intents, and a cross-entropy loss may be used as the objective function. This loss function measures the difference between the model’s predicted probabilities and the actual labels, guiding the optimization of the model’s parameters. During the training process, the model may be applied to the training examples, and based on the measured loss, the model’s weights may be adjusted during training to reduce the loss function and improve the model’s predictions. The training process involves feeding the training data into the model, which iteratively updates its weights based on the feedback from the loss function. For neural networks, this training is often conducted over multiple epochs, with each epoch representing a complete pass through the training dataset.

In some implementations, feedback on response output from the machine learning model may be collected to update/retrain the machine learning model (or other models). For example, if users correct the responses or indicate that the agent misunderstood their queries, this information may be used as feedback. In some implementations, a human may review the generated response to evaluate the model’s accuracy and identify any recurring issues. Based on the feedback analysis, the model training module 212 may update the training dataset to include new examples, corrections, or additional variations of existing queries that reflect the identified issues. The model training module 212 may adjust the models in its architecture, hyperparameters, or training approach based on the feedback. For instance, if the feedback indicates a frequent misunderstanding of certain phrases, updating the training dataset to includes these examples and retraining the model with examples of these phrases may improve accuracy. In some cases, incremental learning techniques may be applied, allowing the model to be updated with new data without requiring a full retrain from scratch.

The data store 214 stores data used by the declarative agent service 130. For example, the data store 214 stores user data, previous conversations, etc. for use by the declarative agent service 130. The data store 214 also stores trained machine-learning models trained by the model training module 212. For example, the data store 214 may store the set of parameters for a trained machine-learning model on one or more non-transitory, computer-readable media. The data store 214 may use non-transitory computer-readable media to store data, and may use databases to organize the stored data.

The response repository 216 stores previously generated responses and/or response templates. For example, some of the user’s intents/queries may be identified as common queries, and high-quality responses may be generated for these queries. The response repository 216 may store the generated responses and/or categorize the responses based on the query or key phrases they correspond to. The response repository 216 may act as a pre-built library of responses that the declarative agent service 130 may access instantly. In some embodiments, the response repository 216 is not static and may be continuously updated based on new data and evolving conversations. As new common queries (e.g., more than a threshold number or percentage of total queries) emerge or existing ones change in frequency, the response repository 216 is refreshed to include updated or additional responses. This ensures that the response repository 216 remains relevant may can effectively handle the most likely queries at any given time.

### COMPUTING MACHINE ARCHITECTURE

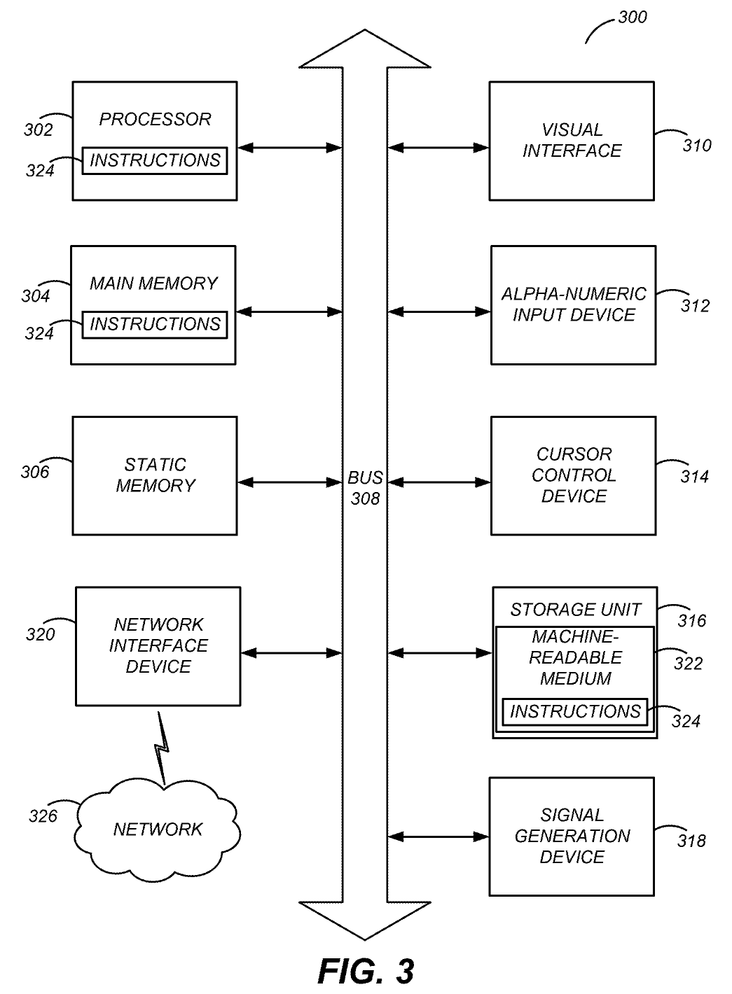

FIG. 3 is a block diagram illustrating components of an example machine able to read instructions from a machine-readable medium and execute them in a processor (or controller). Specifically, FIG. 3 shows a diagrammatic representation of a machine in the example form of a computer system 300 within which program code (e.g., software) for causing the machine to perform any one or more of the methodologies discussed herein may be executed. The program code may be comprised of instructions 324 executable by one or more processors 302. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 324 (sequential or otherwise) that specify actions to be taken by that machine. Further, while only a single machine is illustrated, the term “machine” shall also be taken to include any collection of machines that individually or jointly execute instructions to perform any one or more of the methodologies discussed herein.

The example computer system 300 includes a processor 302 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 304, and a static memory 306, which are configured to communicate with each other via a bus 308. The computer system 300 may further include visual display interface 310. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 310 may include or may interface with a touch enabled screen. The computer system 300 may also include alphanumeric input device 312 (e.g., a keyboard or touch screen keyboard), a cursor control device 314 (e.g., a mouse, a trackball, a joystick, a motion sensor, or other pointing instrument), a storage unit 316, a signal generation device 318 (e.g., a speaker), and a network interface device 320, which also are configured to communicate via the bus 308.

The storage unit 316 includes a machine-readable medium 322 on which is stored instructions 324 (e.g., software) embodying any one or more of the methodologies or functions described herein. The instructions 324 (e.g., software) may also reside, completely or at least partially, within the main memory 304 or within the processor 302 (e.g., within a processor’s cache memory) during execution thereof by the computer system 300, the main memory 304 and the processor 302 also constituting machine-readable media. The instructions 324 (e.g., software) may be transmitted or received over a network 326 via the network interface device 320.

While machine-readable medium 322 is shown in an example embodiment to be a single medium, the term “machine-readable medium” should be taken to include a single medium or multiple media (e.g., a centralized or distributed database, or associated caches and servers) able to store instructions (e.g., instructions 324). The term “machine-readable medium” shall also be taken to include any medium that is capable of storing instructions (e.g., instructions 324) for execution by the machine and that cause the machine to perform any one or more of the methodologies disclosed herein. The term “machine-readable medium” includes, but not be limited to, data repositories in the form of solid-state memories, optical media, and magnetic media.

### EXAMPLE METHOD

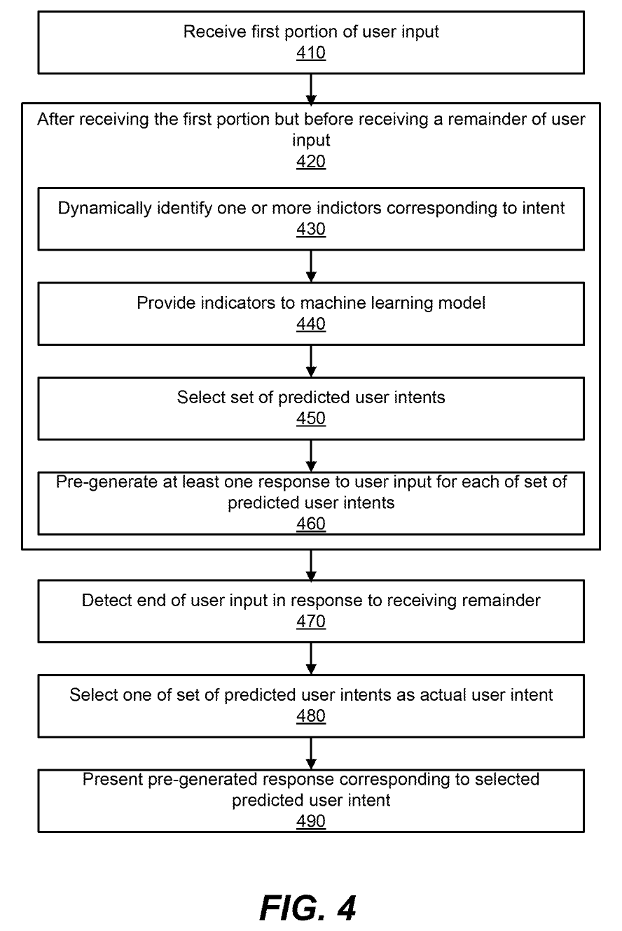

FIG. 4 is a flowchart of a method 400 for presenting a pre-generated response, in accordance with one or more embodiments. Alternative embodiments may include more, fewer, or different steps from those illustrated in FIG. 4, and the steps may be performed in a different order from that illustrated in FIG. 4. These steps may be performed by the declarative agent service 130 or one or more components of the computer system 300 of FIG. 3. Additionally, each of these steps may be performed automatically by the declarative agent service 130 without human intervention from an external operator (e.g., a human who is not a user in a conversation).

The identification module 202 receives, via an agent, a first portion of a user input from a user during a real-time conversation between the agent and the user. In some embodiments, the agent is powered by an LLM, such as Generative AI 140. After receiving the first portion of the user input but before receiving a remainder of the user input during the real-time conversation, the identification module 202 (or, in some embodiments, the agent, which may be part of the identification module 202) dynamically identifies one or more indicators corresponding to an intent of the user based on the first portion of the user input during the real-time conversation. In some embodiments, one or more of the indicators is a pause included in the user input or is a user-specific indicator determined based on patterns observed in previous conversations between the agent and the user.

The prediction module 204 provides the one or more indicators to a machine learning model, such as Generative AI 140, to predict one or more user intents associated with the user input. Each predicted user intent is associated with a confidence score indicating a likelihood that the predicted user intent is an actual user intent. The prediction module 204 selects a set of predicted user intents based on the respective confidence scores. For example, the prediction module 204 may select the set of user intent within a threshold confidence score for the set.

The pre-generation module 206 pre-generates at least one response to the user input for each of the set of predicted user intents. The output module 208 detects an end of the user input in response to receiving the remainder of the user input and selects one of the set of predicted user intents as the actual user intent associated with the user input based on the received remainder of the user input. The output module 208 causes a client device 110 associated with the conversation to present the pre-generated response corresponding to the selected predicted user intent to the user as a response to the user input.

In some embodiments, the model training module 212 may generate a set of training data for the machine learning model. In particular, the model training module 212 may extract, from a set of historical conversations, one or more user inputs and detect an indicator in each user input before an end of the respective user input. The model training module 212 provides the indicator for each user input to the machine learning model, and receives, from the machine learning model, a plurality of predicted user intents for each user input. The model training module 212 (or, in some embodiments, the prediction module 204) determines an actual intent for each user input based on a portion of the respective historical conversation that occurred after the respective indicator and labels each user input with the respective plurality of predicted intents and respective actual intent.

In some embodiments, the method 400 further comprises generating a response template for each set of predicted user intents. The response template may include a structure of text, and the structure of text may be divided by at least one empty portion within the structure. In response to selecting one of the set of predicted user intents, the pre-generation module 204 may generate the response by replacing the empty portions of the respective response template with content. In some embodiments, the pre-generation module 206 loads pre-generated responses into a buffer once each response is finished being generated.

### ADDITIONAL CONFIGURATION CONSIDERATIONS

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for reconciling configuration settings for imported resources through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method comprising:
receiving, by an agent, a first portion of a user input from a user during a real-time conversation between the agent and the user;
after receiving the first portion of the user input but before receiving a remainder of the user input during the real-time conversation:
dynamically identifying, by the agent, one or more indicators corresponding to an intent of the user based on the first portion of the user input during the real-time conversation;
providing the one or more indicators to a machine learning model to predict one or more user intents associated with the user input, each predicted user intent associated with a confidence score indicating a likelihood that the predicted user intent is an actual user intent;
selecting a set of predicted user intents based on the respective confidence scores; and
pre-generating at least one response to the user input for each of the set of predicted user intents;
detecting an end of the user input in response to receiving the remainder of the user input;
selecting one of the set of predicted user intents as the actual user intent associated with the user input based on the received remainder of the user input; and
presenting the pre-generated response corresponding to the selected predicted user intent to the user as a response to the user input.

2. The method of claim 1, further comprising:
generating a set of training data for the machine learning model by:
extracting, from a set of historical conversations, one or more user inputs;
detecting, in each user input before an end of the respective user input, an indicator;
providing, for each user input, the indicator to the machine learning model;
receiving, from the machine learning model for each user input, a plurality of predicted user intents;
determining, for each user input, an actual intent based on a portion of the respective historical conversation that occurred after the respective indicator; and
labeling each user input with the respective plurality of predicted intents and respective actual intent.

3. The method of claim 1, further comprising:
generating a response template for each set of predicted user intents, wherein the response template includes a structure of text, the structure of text divided by at least one empty portion within the structure; and
in response to selecting one of the set of predicted user intents, generating the response by replacing the empty portions of the respective response template with content.

4. The method of claim 1, further comprising loading the pre-generated response in a buffer.

5. The method of claim 1, wherein the agent is an artificial intelligence (AI) agent powered by a language model.

6. The method of claim 1, wherein one of the one or more indicators is a pause in user input.

7. The method of claim 1, wherein one or more of the indicators is a user-specific indicator determined based on patterns observed in previous conversations between the agent and the user.

8. A non-transitory computer-readable storage medium storing instructions that, when executed, cause a processor to perform steps comprising:
receiving, by an agent, a first portion of a user input from a user during a real-time conversation between the agent and the user;
after receiving the first portion of the user input but before receiving a remainder of the user input during the real-time conversation:
dynamically identifying, by the agent, one or more indicators corresponding to an intent of the user based on the first portion of the user input during the real-time conversation;
providing the one or more indicators to a machine learning model to predict one or more user intents associated with the user input, each predicted user intent associated with a confidence score indicating a likelihood that the predicted user intent is an actual user intent;
selecting a set of predicted user intents based on the respective confidence scores; and
pre-generating at least one response to the user input for each of the set of predicted user intents;
detecting an end of the user input in response to receiving the remainder of the user input;
selecting one of the set of predicted user intents as the actual user intent associated with the user input based on the received remainder of the user input; and
presenting the pre-generated response corresponding to the selected predicted user intent to the user as a response to the user input.

9. The non-transitory computer-readable storage medium of claim 8, the steps further comprising:
generating a set of training data for the machine learning model by:
extracting, from a set of historical conversations, one or more user inputs;
detecting, in each user input before an end of the respective user input, an indicator;
providing, for each user input, the indicator to the machine learning model;
receiving, from the machine learning model for each user input, a plurality of predicted user intents;
determining, for each user input, an actual intent based on a portion of the respective historical conversation that occurred after the respective indicator; and
labeling each user input with the respective plurality of predicted intents and respective actual intent.

10. The non-transitory computer-readable storage medium of claim 8, the steps further comprising:
generating a response template for each set of predicted user intents, wherein the response template includes a structure of text, the structure of text divided by at least one empty portion within the structure; and
in response to selecting one of the set of predicted user intents, generating the response by replacing the empty portions of the respective response template with content.

11. The non-transitory computer-readable storage medium of claim 8, further comprising loading the pre-generated response in a buffer.

12. The non-transitory computer-readable storage medium of claim 8, wherein the agent is an artificial intelligence (AI) agent powered by a language model.

13. The non-transitory computer-readable storage medium of claim 8, wherein one of the one or more indicators is a pause in user input.

14. The non-transitory computer-readable storage medium of claim 8, wherein one or more of the indicators is a user-specific indicator determined based on patterns observed in previous conversations between the agent and the user.

15. A system comprising:
a processor; and
a non-transitory computer-readable storage medium storing instructions that, when executed, cause the processor to perform steps comprising:
receiving, by an agent, a first portion of a user input from a user during a real-time conversation between the agent and the user;
after receiving the first portion of the user input but before receiving a remainder of the user input during the real-time conversation:
dynamically identifying, by the agent, one or more indicators corresponding to an intent of the user based on the first portion of the user input during the real-time conversation;
providing the one or more indicators to a machine learning model to predict one or more user intents associated with the user input, each predicted user intent associated with a confidence score indicating a likelihood that the predicted user intent is an actual user intent;
selecting a set of predicted user intents based on the respective confidence scores; and
pre-generating at least one response to the user input for each of the set of predicted user intents;
detecting an end of the user input in response to receiving the remainder of the user input;
selecting one of the set of predicted user intents as the actual user intent associated with the user input based on the received remainder of the user input; and
presenting the pre-generated response corresponding to the selected predicted user intent to the user as a response to the user input.

16. The system of claim 15, the steps further comprising:
generating a set of training data for the machine learning model by:
extracting, from a set of historical conversations, one or more user inputs;
detecting, in each user input before an end of the respective user input, an indicator;
providing, for each user input, the indicator to the machine learning model;
receiving, from the machine learning model for each user input, a plurality of predicted user intents;
determining, for each user input, an actual intent based on a portion of the respective historical conversation that occurred after the respective indicator; and
labeling each user input with the respective plurality of predicted intents and respective actual intent.

17. The system of claim 15, the steps further comprising:
generating a response template for each set of predicted user intents, wherein the response template includes a structure of text, the structure of text divided by at least one empty portion within the structure; and
in response to selecting one of the set of predicted user intents, generating the response by replacing the empty portions of the respective response template with content.

18. The system of claim 15, further comprising loading the pre-generated response in a buffer.

19. The system of claim 15, wherein the agent is an artificial intelligence (AI) agent powered by a language model.

20. The system of claim 15, wherein one of the one or more indicators is a pause in user input.
